(19) United States
(12) Patent Application Publication
(10) Pub. No.: US 2011/0082701 A1
(43) Pub. Date: Apr. 7, 2011

(54) METHOD AND SYSTEM WITH INBUILT INTELLIGENCE FOR FINALIZING AND DELIVERING THE ARCHITECTURE

(76) Inventor: Kamal Sagar, Bangalore (IN)

(21) Appl. No.: 12/520,816

(22) PCT Filed: Dec. 20, 2007
(86) PCT No.: PCT/IN07/00600

§ 371 Date: Jun. 22, 2009

(30) Foreign Application Priority Data
Dec. 22, 2006 (IN) 2414/CHE/2006

(51) Int. Cl. G06F 3/048; G06Q 10/00

(52) U.S. Cl. 705/1.1; 715/771

(57) ABSTRACT

A method and system for inbuilt intelligence for finalizing and delivering the architecture of a space through a web-based and/or offline system is described. The user is allowed to interactively customize the layout and design of the architectural space. The disclosed system validates the user selected options against predefined electrical, mechanical design and other relevant standards. The disclosed method and system also provides the details about the associated costs and relevant architectural drawings during the course of customization. The information including bill of quantities, drawings, specifications, etc., from the user selected options can be extracted and fed into relevant systems for executing and delivering the architectural space.

### FIELD OF INVENTION

The instant invention relates to a computerized system with inbuilt intelligence for finalizing and delivering architecture. It generally relates to all key processes involved in defining the layout, design, estimation of quantities and cost, and specifications, of an architectural space. Further, the instant invention relates to an intelligent system for allowing several users to interactively define and customize the layout and design of an architectural space through a web-based and/or offline system.

### BACKGROUND OF THE INVENTION

The need to condition the environment in which people live has existed as long as mankind on this earth. The solutions have been many and varied, depending upon the availability of shelter, fuel and other resources. In present times, the boost in the economy has been instrumental in increasing both existing and new home sales. Also, there has been a surge in the desire for homeowners to customize and decorate their homes according to their own sensibilities and functional requirements.

Currently, skilled architects and interior designers are relied upon to capture and convert homeowners' requirements into functionally efficient spaces and aesthetically decorated rooms. However, these professional services come at a hefty premium and are resource and time intensive. The homeowner is required to engage a skilled architect and interior designer and invest a number of days to ensure the construction is implemented according to his preferences. Several systems have been proposed to address this issue to allow a homeowner to design their homes, specifically the interior decorations conforming with their design wishes. This is therefore only possible for individual homes or very small projects, and not available for large scale projects with many homes

U.S. Pat. No. 6,572,377 discloses a computerized expert system for providing interior design by allowing a homeowner to enter interior design requirements and selecting interior design treatments according to the homeowner's design requirements so that a grouping of compatible interior design treatments is provided for the homeowner to be used in decorating the homeowner's home.

U.S. Pat. No. 6,727,925 discloses a system for designing a room using a browser connected to a system remote to the browser. The perspective view of the room is displayed. Specification is accepted of furnishings to be added to the room. Simplified images of the furnishings are displayed in the perspective view of the room. Manipulation of the simplified images of the furnishings is accepted and displayed. The room is rendered with substantially photorealistic perspective images of the furnishings in the perspective view of the room. The substantially photorealistic perspective images of the furnishings are obtained from the remote system, and the room is rendered in accordance with the manipulation of the simplified images so as to present corresponding perspective views of the furnishings. Preferably, specification of properties for the furnishings also are accepted and displayed. When the room is rendered, the room preferably is rendered with photorealistic perspective images also in accordance with the specification of independent properties. Specification of a recommended group of furnishings also preferably is accepted.

U.S. Pat. No. 6,999,907 discloses a process comprising identifying assets in a raw architectural CAD drawing, applying compliance and preferred criteria for creating detailed engineering specifications corresponding to said assets and producing detailed engineering CAD drawings and reports. Preferably, one or more preferred databases of criteria augment the criteria needed for compliance with local codes, said preferred databases including architecturally specific criteria and a client's professional, individual and preferred criteria. Repeated use results in ever more complete databases of preferred criteria for enabling a process requiring little or no additional intervention for processing subsequent CAD drawings. Apparatus embodying the process preferably include a computer and an interactive network system and having at least one client terminal for interacting with a client, downloading the client's raw CAD files and uploading detailed output CAD drawings to the client.

However, these systems have been unable to provide an integrated system to assist a homeowner in designing and customizing both the layout as well as the design of their homes or work places. Also, most of these systems require the user to have at least some basic expertise in planning of architecture and designing of spaces. The design and view options are usually limited. The selection and customization of the various options is not restricted by any rules for adherence to basic architectural and design specifications and is only dependent on the preference of an unskilled user. Further, the costs associated with the implementation of the customizations can not be reliably calculated using such systems. Moreover, large real estate projects do not offer the option of individual customizations to users.

Hence, there is a need for an intelligent system and method that would provide and integrated solution to enable a user without any expertise in architectural planning and design to customize both the layout as well as the design of an architectural space. The system should be able to operate in both online as well as in offline mode. The system should be able to provide the user with a plurality of options and generate final drawings as ‘Good for construction’ that can be executed by the relevant professionals. The system should be able to validate the user's choices against specific architectural standards and prevent erroneous decisions to be made with regards to design and layout. Further, the system should be able to present a dynamic and concurrent estimate of the amount and kind of resources required for realizing the user's design during customization to aid in budgeting and decision making. Still further, the system should be able to extract and categorize relevant information from the final version submitted by the user. The extracted information should be delivered to relevant merchants and professionals for final execution through one or more system coupled to the disclosed system of the instant invention.

### OBJECTS AND SUMMARY OF THE INVENTION

The present invention has the objective to provide an intelligent system to enable a user without any special expertise in the field of architectural design to design and customize both the layout as well as the design of an architectural space in both online and offline modes.

It is also an objective of the instant invention to provide an intelligent system that enables the user to customize the layout and design of an architectural space according to his preferences, said preferences being validated by the system against one or more standard architectural specifications.

It is still another objective of the instant invention to provide an intelligent system that displays relevant drawings and associated costs during the customization process to enable the user to make appropriate choices according to his budget and preferences.

It is yet another objective of the instant invention to provide an intelligent system that generates final drawings and bill of quantities of the user-customized layout and design plans to be used for executing the construction.

To achieve the aforesaid objectives the instant invention provides a method for customizing and delivering architecture comprising the steps of:
displaying options for customizing a space;
receiving user selected customization options;
validating the user selected customization options;
manipulating perspective images of individual elements in perspective view of the space;
rendering photorealistic perspective images of individual elements in perspective view of the space;
creating several alternative choices for the user;
generating and outputting cost, drawings, bill of quantities, and specifications associated with user selected customization options

The instant invention further provides a system for customizing and delivering architecture comprising
means of storing architectural elements and associated data
one or more I/O interfaces for accepting user input and outputting output deliverables
one or more network interfaces
means for validating user input
means for manipulating and rendering perspective images of individual elements in perspective view of the space

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary system with inbuilt intelligence for finalizing and delivering architecture.

FIG. 2 illustrates a flow diagram of the different phases of implementation of an exemplary method of the instant invention.

FIG. 3 is a flow diagram illustrating the layout customization phase of an exemplary method of implementation of the instant invention.

FIG. 4 is a flow diagram illustrating the design customization phase of an exemplary method of implementation of the instant invention.

### DETAILED DESCRIPTION

A method and system with inbuilt intelligence for finalizing and delivering the architecture are described. The system and methods are not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

In order to empower users to be able to design their own living and working spaces, an intelligent system is required that provides a plurality of customization choices to the user. To this effect, the disclosed system and method allows users to select of one or more customization options through interactive menus available in both online and offline modes. The system further validates the user selected options against specific standards to prevent impractical customizations. The disclosed system also allows the user to maintain multiple versions of the selections made until a final version is submitted to the system.

The disclosed method and system can be implemented in two phases namely—Layout and Design. The Layout phase is used to make choices for the interior layout of the architectural space. In the Layout phase, one or more walling schemes can be applied for one or more individual spaces. Based upon the walling scheme applied, the disclosed system can present user with one or more pre configured and/or selectable options of location and layout of furniture. Based on the Furniture Layout selected above, Electrical Layout can be chosen. The disclosed system can present the user with electrical configurations valid for all selected furniture layouts, while automatically populating the ones applicable to the furniture layout selected in the previous phase of customization. The system is programmed to provide the users only those combinations of options that do not create conflict on account of non compliance with set electrical, mechanical and design standards.

In the Layout phase, customisation of provision of services can also be made. Air conditioning can be enabled or disabled for individual spaces or selection between alternative air conditioning systems can be made. Specialized plumbing options like solar water heater plumbing, gas plumbing, etc. can be selected. Further home automation options such as for security and lighting control can be selected.

In the Design phase, the user can select design options for the layout choices made. The system provides the user with a plurality of options for the design of interior elements such as doors and windows, ornamentation, partition, shelves, mosquito panels, landscape items and so on. Based on the furniture layout selected, related selections of design of woodwork, hardware, loose furniture and curtain pelmets and so on can be selected at this phase. Further, options for the flooring, tiling, veneer, fabric and paint that are aesthetically appropriate to the flooring material chosen in the previous phase of customization can be selected. The design options presented to the user can be controlled to be intelligently grouped for appropriate aesthetics and freedom to customers to choose any of the available options and still maintain coordination in the look and feel of the space.

During the Design phase, sanitary, plumbing, electro-domestic and electrical fixtures can also be selected in accordance with the choices made during the furniture and electrical layout phases. Home appliances/applications like Air conditioners, solar water heaters and home automation system/s may also be selected from a plurality of options. During the abovementioned course of customization, relevant data regarding costs and required material specifications associated with each option can be displayed to the user for budgeting purposes. The user can finalize one version and submit it to the system for approval. The disclosed system can facilitate direct generation of drawings ‘to be released ‘Good for Construction’ to be executed by an architect and/or construction professional. Further, the relevant data of cost, material specifications, bill of quantities, etc. can be extracted and released for site execution and record. The data can be fed onto an ERP System for project monitoring and implementation. The system can also be configured to allow a customer to use all the modules available for customization or parts thereof depending on project specifications and requirements to make his choices.

The techniques described herein may be used in many different operating environments and systems. An exemplary environment that is suitable for practicing various implementations is discussed in the following section with respect to the accompanying figures.

### Exemplary System

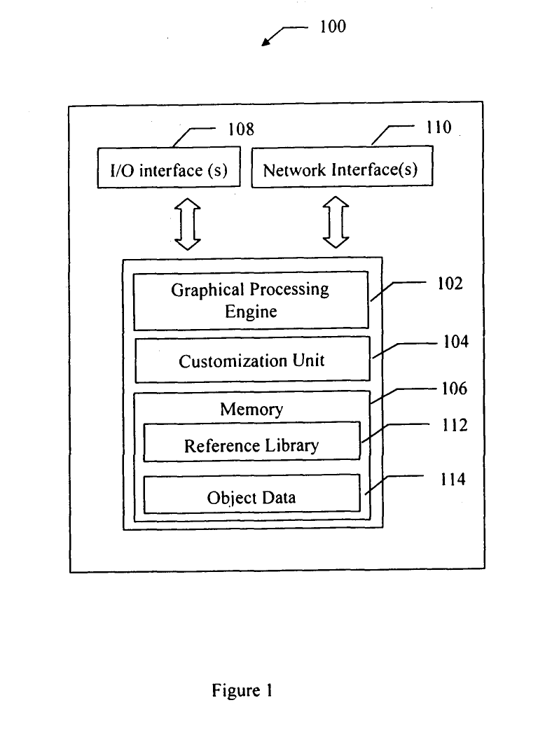

FIG. 1 illustrates an exemplary system 100 with inbuilt intelligence for customizing and delivering architecture. According to an embodiment, exemplary system 100 can include graphical processing engine 102 coupled to a customization unit 104, memory 106, one or more I/O interfaces 108 and one or more network interfaces 110. Graphical processing engine 102 can be a single processing entity or a plurality of processing entities comprising multiple computing units. Customization unit 104 can be configured to extract relevant information from user defined choices during customization. Customization unit 104 can further store relevant architectural rules and standards to validate and parse the user defined choices during the course of customization. In alternate embodiments, customization unit 104 can be incorporated within the graphical processing engine 102 or memory 106. Memory 106 can include, for example, volatile memory (e.g., RAM) and non volatile memory (e.g., ROM, flash memory, etc.). The operational instructions and relevant data stored in memory 106 can be executed by the Graphical processing engine 102.

I/O interfaces 108 can provide input output capabilities for system 100. I/O interfaces 108 can include one or more ports for connecting a plurality of input devices, output devices, analog and digital converters and so on. I/O interfaces 108 can be configured for accepting user input for customization of an architectural space through one or more input devices, for example, keyboard, mouse, etc. System 100 can be coupled via one or more network interfaces 110 to one or more communication channels. The communication channel can be a wired or a wireless communication network such as Internet, local area network (LAN), wide area network (WAN), and so forth.

Memory 106 further comprises reference library 112 and object data 114. After graphics processing engine 102 loads the reference library 112 into the memory 106, it facilitates the generation of the output images through the I/O interfaces 108. Reference library 112 can store a plurality of factors associated with a given architectural element such as color, material, cost and dimensions and so on. Reference library 112 can further include information regarding possible positioning of elements in an architectural space. The information in the reference library 110 can be correlated with attributes of user input as captured during the customization process.

Object data 114 can include program objects and related data that are created in conjunction with information stored in reference library 112. Object data 114 can include possible visual effects for any position of a design element relative to another element such as a floor, table, wall etc. Object data 114 can further store session information for a user during the customization process, so that the user may end a session mid-stream and return to the session without losing any of the previous input. A plurality of sessions for a specific user can also be stored in object data 114.

Customization unit 104 can be configured to validate and parse user defined choices during the customization process based on a plurality of predefined rules. The rules can include specified criteria, interpretation and incorporation of engineering design standards during the customization process. The rules may include General Engineering Standards (GES), Specific Engineering Standard (SES), a plurality of design standards and so forth. Some of the rules can be absolute and static, such as, type and the number of individual elements of the electrical service for a specific architectural space with a specific use. Other rules may be preferred rules that can be variable or adjustable, such as, where ceiling mounted lighting fixtures are placed in a room, they are to be located appropriately so as to provide proper lighting levels everywhere in the room.

System 100 can be implemented in offline mode and/or as a web server or can be made available online through a browser based system connected to a network. On initialization, graphical processing engine 102 can load the reference library 112 and other relevant data into memory 106. In an embodiment, a start page, preferably a user-login page can be displayed on the screen. The login credentials and related data can reside locally in memory 106 or in one or more data sources accessible over the network. The login credentials can further include information such as user's personal information, location, type of services for which the user is eligible, validity period and so on. Upon positive identification of the user, the disclosed system 100 can provide the user with the options to initiate customization based on preloaded themes or customizing ground-up. If theme based customization is selected, the graphical processing engine 102 can load the relevant information of already grouped options confirming to a particular theme for one or more phases of customization from the reference library 112 onto the memory 106.

If the user selects the ground-up customization option, graphical processing engine 102 can load all the different customization options from reference library 112 into memory 106. Based on the user information determined during login, the user can be allowed to customize the architectural space in one or more flows, namely, layout customization and design customization. Graphical processing engine 102 can present the user with appropriate choices during the customization process based on user's previous selections stored as part of object data 112. Customization unit 104 can also be configured to present the user with only those choices from reference library 112 that comply with predefined electrical, mechanical and other related design standards, created for the particular project.

Further, graphical processing engine 102 can provide option to scale and modify attributes and location of one or more elements in the architectural space. Graphical processing engine 102 can generate 3-D imaging of all elements within the architectural space during customization by the user for a more realistic view. The details such as the cost and dimensions associated with each of the user selected options can be displayed during the process of customization. The session details can be stored in object data 114. Multiple session information can be stored for a specific user in object data 114. Once the user submits his final layout and/or design, the graphical processing engine 102 processes the captured information to generate drawings ‘to be released Good for Construction’. In one embodiment, CAD drawings that can be used by relevant professionals to execute the user's design can be generated by an output device such as display screen and/or printer coupled to system 100 through one or more I/O interfaces 108. Further, the relevant data of cost, material specifications, bill of quantities, etc. can be extracted, displayed and/or printed through I/O interfaces 108. The finalized architectural drawings and information regarding cost and quantity of required resources can be fed onto an ERP System coupled to system 100 for project monitoring and implementation by relevant professionals.

### Exemplary Method

Exemplary method for enabling a user without any special expertise in the field of architectural design to customize and deliver both the layout as well as the design of an architectural space is described. Processes 200, 300 and 400 are illustrated as a collection of blocks in a logical flow graph, which represents a sequence of operations that can be implemented in hardware, software, or a combination thereof. In the context of software, the blocks represent computer instructions that, when executed by one or more processors, perform the recited operations. The order in which the process is described is not intended to be construed as a limitation, and any number of the described blocks can be combined in any order to implement the process, or an alternate process. Additionally, individual blocks may be deleted from the process without departing from the spirit and scope of the subject matter described herein. For discussion purposes, the processes 200, 300 and 400 are described with reference to the implementations of FIG. 1.

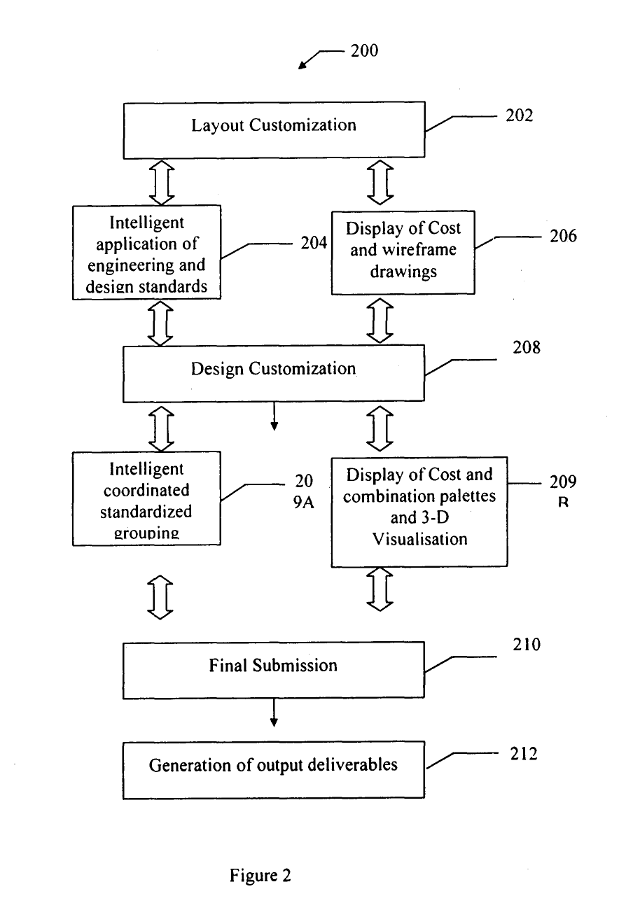

FIG. 2 illustrates the different phases of implementation of an exemplary method 200 for implementing the proposed method of customizing and delivering architecture. The disclosed system and method of the instant invention can be implemented in offline mode as a standalone application. In another embodiment, the disclosed system and method of the instant invention can be implemented in online mode as a web server accessible via a browser based system. In the disclosed method, a login page can be displayed to capture user details. The login credentials and related data can reside locally in memory 106 in a standalone application or in a web server or in one or more data sources accessible over the network. On successful login, information associated with a user such as personal information, location, type of services for which the user is eligible and validity period during which the user can use the application can be retrieved.

Based on the user information determined during login, the user can be allowed to customize the architectural space in one or more flows and access one or more features of the disclosed system. The user can be presented with the option to initiate/modify customization based on preloaded themes or customizing ground-up. If theme based customization is selected, customization unit 104 directs graphical processing engine 102 to load predetermined choices and relevant information for the user selected theme for one or more phases of customization. Predefined options can also be presented to the user based on a plurality of selectable factors such as the preferred type of architecture, community, lifestyle, surrounding elements, and so on. If the user selects the ground-up customization option, all the different selectable options for one or more phases of customization can be presented to the user.

At block 202, system 100 enables the user to make intelligent choices during the process of customization. Predefined engineering and design standards built into the system can be used to parse and validate the user-selected options. During theme based customization, the graphical processing engine 102 loads only those elements and their associated variables from reference library 112 that are compatible with the user selected theme. The user is not allowed to select options that violate the absolute rules which can not be changed. Alternately, the options that violate absolute and static standards can be disabled or can be removed from the list of customizable options presented to the user. System 100 can accept other customization choices and/or provide a gentle warning to the user regarding choices that may be changed. System 100 thus, provides the users with only those options that do not create conflict on account of non compliance with predefined electrical, mechanical and design standards. The disclosed method of customization by a user is facilitated without any support from a technical person. In a large scale construction project, the customization option provided to the user can also be validated by the in built intelligence to conform to the specifications of the other architectural spaces that form part of the project.

At block 204, the user can customize the layout of the architectural space. In the Layout phase, one or more walling schemes can be applied for one or more individual spaces. Furniture layout compatible with the walling option selected by the user can be presented to the user. Further, electrical and services layout options can also be selected during this phase of customization. The electrical options available to the user depend on the options selected in previous steps. Similarly, the service layout options can be customized depending upon their compatibility with the choices made during earlier phases of customization. The compatibility can be determined using the inbuilt intelligence of the system that does not allow the user to make any wrong customization choices.

At block 206, computation of cost associated with each of the elements selected by the user during the customization process is displayed. Further, based on a plurality of factors related to the area being customized, automatic breakup of associated costs can be displayed for every change to address budgeting concerns. Still further, simplified drawings of the perspective images of individual elements in perspective view of the space at every step and/or with each and every change can be displayed to aid the user to address his design preferences. Without limitation, this perspective view functionality is may be available at the layout stage as also in the plan layout

At block 208, the design phase of the customization of the architectural space can be implemented. The user can customize space by space and item by item the interior design of the architectural space according to the user's budget and design preferences. At block 209A, the inbuilt intelligence in the system provides the user with only those design options that are compatible with the layout choices made. The system provides the user with a plurality of options for the design of interior elements woodwork, finishes, and fixtures and so on. Further, options for customizing sanitary plumbing, electro-domestic, electrical fixtures, air conditioners, solar water heaters and home automation tools can also be selected in accordance with the choices made during the furniture and electrical layout phases. System 100 enables the user to incorporate only those design elements for which the provision had been made by the user during the layout customization phase. At block 209B, system 100 further facilitates display of associated photorealistic images, including 3D images, and relevant data regarding costs and material specifications associated with each design option selected to address the user's design and budgeting concerns.

System 100 allows the user to maintain multiple versions of the layout and design customization of a specific architectural space for comparison. At block 210, the user can submit the finalized version of the customized space to the system. System 100 can extract relevant information from the user selected customization options and feed into an ERP system coupled to system 100 through one or more interfaces.

At block 212, the information extracted from the final version of the user's customization can be used to generate drawings ‘to be released Good For Construction’ that may be utilized by the relevant professionals to implement the user's customizations. Further, relevant data regarding cost, material specifications and bill of quantities can be extracted and released for site execution and record. System 100 can display and/or print the drawings and relevant data through one or more display screens and printers coupled to system 100 through I/O interfaces 106.

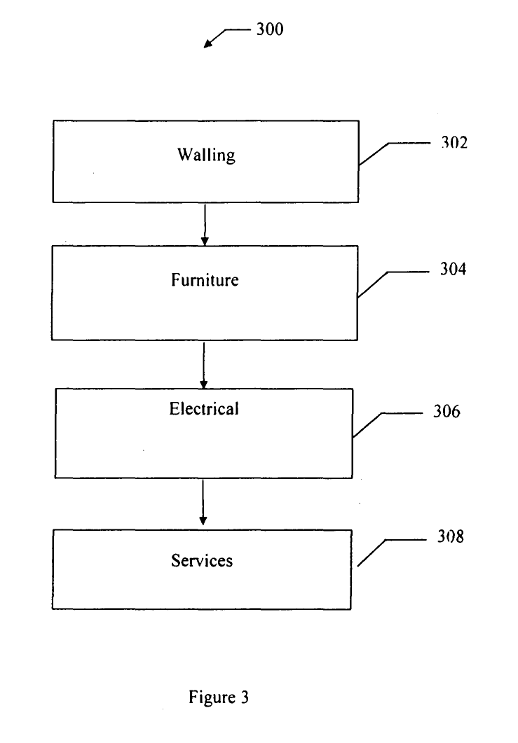

FIG. 3 illustrates an exemplary method 300 for customizing the layout of the architectural space facilitated by the inbuilt intelligence in system 100. The layout phase involves customization of the interior layout of an architectural space in one or more stages, each stage taking care of a different aspect of customization. System 100 further, displays the associated costs and relevant drawings of the architectural space when the user selects one or more elements during the customization process. The Drawings may be simplified illustrations and/or a photorealistic 3D illustration of the space and associated elements under customization.

At block 302, the walling layout of the architectural space can be customized. Walling layout deals with selection of different options for individual spaces. Options can be provided for each space, each option corresponding to a plurality of such as sizes of spaces, door locations, a closed or open feel, traditional or contemporary setup and other such configurations based on individual taste. The internal walls can be redone, removed, or shifted, while the external walls remain constant. The walling scheme is validated by the inbuilt intelligence in system 100 against a plurality of factors such as total area, supporting structures, intended use of space and so on.

At block 304, the furniture layout can be customized. Based upon the walling scheme applied, the disclosed system can present user with one or more pre configured and/or selectable options of location and layout of furniture. For a specific walling scheme, a plurality of furniture layouts can be available. The selections can be validated using the inbuilt intelligence of the disclosed system 100 for compliance with predefined standards and/or selected themes. At this stage the size and type of furniture compatible with the overall layout is selected. At a future stage (at block 404), the styling, finish and other design choices for the furniture selected can be defined. For example, Victorian furniture selections of appropriate size may be displayed to the user for selection if the selected theme is Victorian architecture. Their specifications are then defined in detail at Block 404. Another example can be installation of an MRI machine in a hospital room. Since an MRI machine produces strong magnetic field, no metallic equipment should be within its reach. Hence, only choices that do not create conflict on account of such specific prerequisites would be available to the user for selection.

At block 306, the electrical layout can be customized. Based on the Furniture Layout selected by the user, electrical layout for a specific architectural space can be customized according to the user's requirements. The disclosed system 100 can present the user with electrical configurations valid for all furniture layouts, while automatically populating the ones applicable to the furniture layout selected in the previous phase of customization. The user can enable or disable electrical points or configure the electrical layout to shift controls for electrical points from one switchboard to another or add switch sockets, phone point, and T.V. point and so on. For example, the electrical options available for a room to be used as a studio would be different from those if it were to be used as a bedroom on account of the difference in use, dimensions and the furniture. The system provides the users with only those options that do not create conflict on account of non compliance with set electrical, mechanical and design standards.

At block 308, provision of customized services can also be made. During the services' customization phase, air conditioning can be enabled or disabled for individual spaces or changed/upgraded to other pre configured air-conditioning system. Specialized plumbing options like solar water heater plumbing, gas plumbing etc. can be selected. Further home automation options such as for security and lighting control can be selected. The security options can be selected in high-end, advanced and basic layouts. The disclosed system can automatically calculate the power requirement for the architectural space based on the choice of electrical points, switches, sockets, etc. made in the electrical phase. A choice of wiring, whether, single Phase or three phase, can be made available in this phase. The system validates the user's choice against set electrical standards such as, for power requirements of more than 6 KVa, the system automatically allows only three phase wiring. The inbuilt intelligence in the disclosed system 100 allows, the user to select only those choices which are compatible with the load that is created by the heating and lighting circuits.

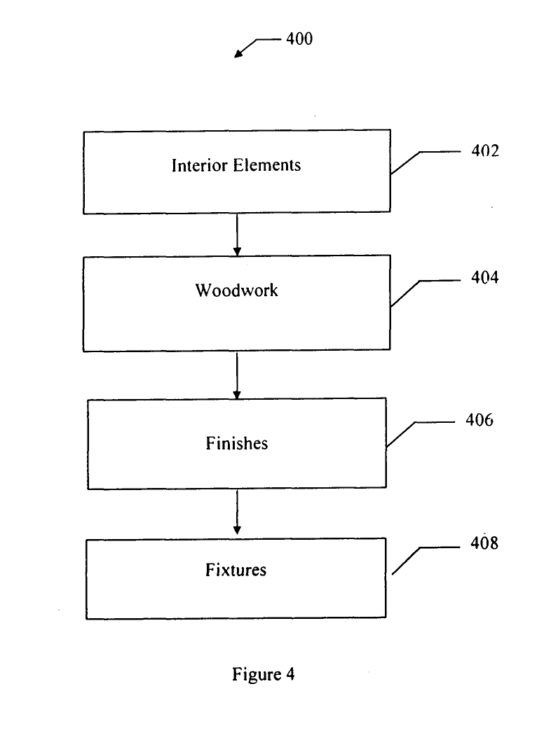

FIG. 4 illustrates the Design phase of an exemplary method of implementation of the disclosed method of the instant invention. In this phase, the user can customize one or more elements in the interior design of one or more spaces. A 3D illustration of the architectural space can be displayed during the design phase. The view may be scalable, can be modified using zoom feature and can be localized on a single element. 3D illustration facilitates more realistic view of the space as it would look after the implementation of the design. The 3D view can also be provided for the various elements such as fixtures that can be incorporated during the course of customization. This can also enable the manufacturers of a plurality of elements that may be incorporated during the design phase to showcase their wares to prospective users. Further, associated costs and drawings may be displayed as the user selects one or more customization options.

At block 402, system 100 can provide the user with a plurality of options for the design of interior elements. The interior elements that can be customized in this phase can include doors and windows, ornamentation, partitions, shelves- and niches, mosquito panels, landscape items and so on. The options that can be selected for customizing the interior elements should adhere to the user selected-theme and/or previous choices made during the layout customization phase.

At block 404, related selections of design of woodwork, hardware, loose furniture and curtain pelmets and so on can be selected at this phase. The options for customizing the woodwork are available as coordinated sets based on the furniture layout selected during the layout customization phase

At block 406, the finishes for the floor, veneers, fabrics, paints etc. can be customized as per the user's preference. The system populates intelligently grouped material sets with options therein that are aesthetically appropriate. For example, specific types of skirting, inlay, etc. that go with specific types of flooring materials can be selected. In further phases of customization, options for customizing veneer, fabric and paint that are aesthetically appropriate to the flooring material chosen in the previous phase can be selected. The finishes may themselves be intelligently grouped for appropriate aesthetics by the inbuilt intelligence in system 100.

At block 408, fixtures for one or more spaces can be customized. Sanitary plumbing, electro-domestic and electrical fixtures can be selected in accordance with the choices made during the furniture and electrical layout phases. Air conditioners, solar water heaters and home automation system may also be selected from a plurality of options.

The option of brand of the appliances can be made only for the spaces for which the client has enabled provision in the layout phase. The 3 D view of the selectable options and the customized space can be used by manufacturers to reach users with the intent of buying their wares. At the same time, this also facilitates the users to find and order for appropriate furnishings from a single source such as the disclosed system 100. System 100 can be coupled to various merchants and commercial establishments through one or more network interfaces 108.

Alternately, relevant information can be extracted and fed into an ERP system coupled to disclosed system of the instant invention. The relevant information can be recorded, analyzed, categorized and sent to other relevant systems such as to manufacturers as Bill of quantities, architects as drawings, and associated costs to user/construction agent and so on. Thus, the entire process of customizing and delivering the layout and design of an architectural space such as one's home or office can be facilitated by system 100 with inbuilt intelligence.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

It will readily be appreciated by those skilled in the art that the present invention is not limited to the specific embodiments shown herein. Thus variations may be made within the scope and spirit of the accompanying claims without sacrificing the principal advantages of the invention.

What is claimed is:

1. An integrated method for designing, customizing and delivering architecture comprising:
administratively configuring said architecture with at least one option or element for customizing at least one architectural element within an architectural space;
administratively defining rules to ensure integration between said options;
administratively adding/deleting said architectural element that can be configured or defined with said options;
administratively defining/changing a sequence of said options for said architectural element according to user requirement;
administratively generating relevant information associated with the architectural element;
displaying to the user said options for customizing said architectural element in the architectural space;
receiving the user selected options for customizing the architectural element;
said user being able to select at least one related and/or unrelated option or element;
validating the user selected customization options against administrator specific standards to prevent impracticable customizations;
applying the validated selected options according to a predefined sequence of steps in the said architectural space;
manipulating perspective images of individual elements in perspective view of the space;
rendering perspective images of individual elements in perspective view of the space;
generating and outputting cost and drawings associated with validated user selected customization options.

2. The method as claimed in claim 1, wherein displaying options comprises the step of displaying options from one or more predefined groups.

3. The method as claimed in claim 1 wherein the said method can be performed online or offline.

4. The method as claimed in claim 1, wherein displaying options comprises the step of displaying options for customizing the layout and the design of the space.

5. The method as claimed in claim 1, wherein validating the user input comprises the step of comparing with predefined electrical mechanical and design standards.

6. The method as claimed in claim 1, wherein validating the user input comprises the step of determining compliance with user selected customization options selected during one or more previous phases of customization.

7. The method as claimed in claim 1, wherein generating and outputting cost and drawings includes generating CAD drawings.

8. The method as claimed in claim 1, wherein generating and outputting cost and drawings includes generating bills of quantities.

9. The method as claimed in claim 1, wherein rendering perspective images includes rendering wireframe images of the individual elements and the perspective space.

10. A system for customizing and delivering architecture comprising:
means of storing architectural elements and associated data;
one or more I/O interfaces for accepting user input and outputting output deliverables;
one or more network interfaces;
means for validating user input;
means for manipulating and rendering perspective images of individual elements in perspective view of the space.

11. The system as claimed in claim 10, wherein associated data includes attributes of the architectural elements, associated costs of architectural elements, visual effects associated with the positioning of the architectural elements and predefined electrical mechanical and design standards.

12. The system as claimed in claim 10, wherein the system can operate in offline mode as a standalone application.

13. The system as claimed in claim 11, wherein the system is a web server accessible over a communication network through a web browser

14. The system as claimed in claim 9, wherein means for validating store predefined electrical mechanical and design standards and rules for determining compliance with user selected customization options selected during one or more previous phases of customization.

15. The system as claimed in claim 10, wherein output deliverables includes wireframe images of perspective images of individual elements in perspective view of the space, 3-D images of perspective images of individual elements in perspective view of the space, associated CAD drawings of customized architecture and bill of quantities.

16. A computer program product for customizing and delivering architecture, comprising one or more computer readable media configured to perform the method as claimed in claim 1.
